(19) United States
(12) Patent Application Publication
(10) Pub. No.: US 2003/0204592 A1
(43) Pub. Date: Oct. 30, 2003

(54) System for uniquely identifying assets and subsribers in a multi-media communicaion network

(75) Inventors: Susan Crouse-Kemp, Broomfield, CO (US); Timothy Hanafee, Parker, CO (US); Trent Hein, Boulder, CO (US); Ned McClain, Littleton, CO (US); Jennifer Ross, Boulder, CO (US); William Snyder, Lafayette, CO (US)

Correspondence Address: PATTON BOGGS, PO BOX 270930, LOUISVILLE, CO, 80027, US

(73) Assignee: Crown Media Holdings, Inc.

(21) Appl. No.: 10/092,709

(22) Filed: Mar. 7, 2002

(51) Int. Cl. H04N 7/16; G06F 15/173; G06F 15/16

(52) U.S. Cl. 709/225; 709/229; 725/25

(57) ABSTRACT

The present system for uniquely identifying assets and subscribers in a multi-media communication network assigns a unique and substantially self-identifying signature to every asset managed by the multi-media communication network as well as the subscribers who access the multi-media communication network. The signature ID system operates as an overlay on the multi-media communication networks to receive individual subscriber requests for a selected multi-media asset and deliver that asset as desired to the requesting subscriber. This service is facilitated by the use of the signature ID system which is used to assign each subscriber and asset a unique identification, that contains both immutable and dynamically assignable segments. The registration system component functions to authorize the registration of subscribers and/or assets and assign their respective unique identification. In addition, the content authority component uses the subscriber identifier and asset identifier to determine whether a subscriber is authorized to access assets, and to initiate the delivery of that asset to the subscriber via a communication medium.

### FIELD OF THE INVENTION

This invention relates to multi-media communication networks and to a system that is operable in this network to uniquely identify both assets (consisting of objects, entities and relationships among them) and subscribers (and bundles) to thereby manage the subscribers' access to selected assets.

### PROBLEM

It is a problem in multi-media communication networks to efficiently serve the subscribers by providing access to specific multi-media assets that are of interest to the subscriber. The multi-media assets can be an individual file or a set of files.

There are a number of existing communication networks that serve to provide a subscriber with access to selected multi-media asset sources. These communication networks include the Public Switched Telephone Network (PSTN), cellular communications systems, the Internet, Cable Television (CATV) systems, Satellite communication systems, and the like. These various communication networks each provide a communication medium that is used to deliver selected multi-media assets to the subscriber from either predetermined or subscriber selected multi-media asset sources. These multi-media asset sources can be broadcast stations (such as cable television channels) that transmit a stream of files (programs) to subscribers or can be multi-media asset repositories (such as a WEB site or a video on demand system) that deliver a multi-media asset to the subscriber upon receipt of a request from the subscriber.

It is a problem in all of these systems to provide the subscribers with access to multi-media assets of interest to the subscriber on an individual basis, via a communication medium that has sufficient bandwidth to deliver the multi-media asset with the desired quality of service and to the desired device. Existing high bandwidth systems deliver blocks (in terms of cable delivery, a plurality of linear programs) of program channels to the subscriber on a subscription basis, with the programs being transmitted at predetermined times so the subscriber can only select which of the plurality of concurrently transmitted channels is received by the subscriber's terminal device. Therefore, the subscriber is unable to obtain customized and efficient access to multi-media assets. Existing architectures and business models have been formed with a narrow function/singular media type in focus—also single-functionality devices and utility-operated infrastructure-service entities.—each with its own relationship with a subscriber that may consume the services and/or utilize the infrastructure of several entities.

There is no multi-media communication network that presently has the capability to provide the granularity of selection to the subscriber to enable the subscriber to have an individualized selection of multi-media assets. This includes the inability of the subscriber to select and self-program and/or schedule a suite of content types or services independent of the type/operator of infrastructure or traditionally targeted device. The enables the subscriber to create an individualized suite of broadcast program channels as their service subscription as well as the individual selection of a multi-media asset for immediate or subscriber programmed delivery.

### SOLUTION

The above-described problems are solved and a technical advance achieved in the field by the present system for uniquely identifying assets and subscribers and devices in a multi-media communication network (also termed “signature ID system” herein) that assigns a unique and substantially self-identifying signature to every asset (which can include metadata describing the association of objects, a description of a service, a service or any other identifiable quality) managed by the multi-media communication network as well as the subscribers who access the multi-media communication network.

The signature ID system operates as an overlay on the multi-media communication networks to receive individual subscriber requests for a selected multi-media asset and deliver that asset, as desired, to the requesting subscriber. This service is facilitated by the use of the signature ID system which is used to assign each subscriber and asset a unique identification (“subscriber identifier”, “asset identifier”), that contains both immutable and dynamically assignable segments. The registration system component functions to authorize the registration of subscribers and/or assets and assign their respective unique identification. In addition, the content authority system component uses the subscriber identifier and asset identifier to determine whether a subscriber is authorized to access assets, and to initiate the delivery of that asset to the subscriber via a communication medium. The number of physical elements used to implement the components of the signature ID system and their locations are a matter of engineering choice, since they operate in a coordinated manner to implement a virtual functionality as viewed by the users.

The subscriber identifier includes an immutable segment that uniquely identifies the registrar that enrolled the subscriber and includes a registrar provided unique identification of the particular subscriber. The subscriber identifier also includes a dynamically assignable segment that can be varied as needed to define various service-related attributes, such as: the subscriber terminal device, quality of service, service provider, subscription service, and the like. The asset identifier also includes an immutable segment that uniquely identifies the registrar that enrolled the asset and includes a registrar provided unique identification of the particular asset. The asset identifier also includes a dynamically assignable segment that can be varied as needed to define various service-related attributes, such as: rating, expiry date, quality of service, and the like.

This system of unique asset identification and unique subscriber identification enables the customization of service delivery to the subscriber and also enables an authoring system to associate objects within a product or between products, between and among entities and similar or different systems by referencing uniquely identified assets, without having to modify the assets or collect the assets into a completed program that comprises a single/immutable flattened presentation. Thus, the authoring system operates by association, and can simply use meta-data to identify an asset that is to be used in the final rendering of the program as delivered to a requesting subscriber on any subscriber selected device. If a program comprises a plurality of assets, the assets can be retrieved as needed for delivery in real time to the subscriber rather than being pre-assembled. The use of asset identifiers thereby enables the multi-media communication network to manage the storage and delivery of assets that are complete programs and the assets that comprise elements of a program on a data storage and data transmission efficiency basis rather than on a temporal schedule basis. The delivery of these assets is independent of the network resources and subscriber device location, with each subscriber being capable of having multiple devices and multiple sets of characteristics.

### BRIEF DESCRIPTION OF THE DRAWING

FIG. 1 illustrates in block diagram form the overall architecture of the present system for uniquely identifying assets and subscribers in a multi-media communication network and various environments in which it is operational;

FIGS. 2A & 2B illustrate in block diagram form a specific implementation of the present system for uniquely identifying assets and subscribers in a multi-media communication network in a cable television environment;

FIG. 3 illustrates in block diagram form a simplified version of FIG. 2;

FIGS. 4A-4C illustrate in flow diagram form the operation of the present system for uniquely identifying assets and subscribers in a multi-media communication network to serve a subscriber request for transmission of a selected multi-media asset to a selected destination;

FIG. 5 illustrates a typical format of a signature identification format for both subscribers and multi-media assets for use in the present system for uniquely identifying assets and subscribers in a multi-media communication network; and

FIGS. 6A-6D illustrate in flow diagram form the operation of the registration system component of the present system for uniquely identifying assets and subscribers in a multi-media communication network to assign an unique signature identification to an object.

### DETAILED DESCRIPTION

Entity Descriptions

Authority: As used in the definition of bit fields, Authority is the administrative entity that defines the meaning or interpretation of a particular field. Every field defined in the Signature ID specification is assigned an authority, with control over the specification of the exact meaning and allocation of bits within that field. Although a variety of entities may set and modify a given field's bits, only the field authority can define the meaning of those bits.

Global Identification Registry (GIR): Global Identification Registry is the entity that has overall responsibility for standardizing aspects of the identification schema, and is the master entity that assigns control over bit-range segments within identification numbers to sub-entities such as Content Authorities and Registrars (defined below).

Registrar: A Registrar is an entity responsible for registering, identifying and managing/distributing data about new assets and subscribers within the Signature ID system according to the identification schema defined by the Global Identification Registry. Registrars are authorized by the Global Identification Registry.

Content Authority (CA): The Content Authority provides a system/service for Subscribers to purchase, package services (like a long-distance company or cable company) and/or settle payments for third-party products, separate from the Access service.

Ratings Authority (RA): A Ratings Authority is an entity that promotes a standardized method for rating content and its appropriateness for particular classes of Subscribers. A Ratings Authority may be an independent entity that serves one or more Content Authorities/Service Providers, or it may be a function of a Content Authority or a Service Provider.

Multiple System Operator: Multiple System Operator is an infrastructure provider (aka cable television company) that controls a particular region or infrastructure collection.

Service Provider (SP): A Service Provider is an entity that owns and/or manages/operates the infrastructure that provides bandwidth (network access, cable access, data access, etc.) to a Subscriber. In this context, a Multiple System Operator is considered to be a Service Provider. The term Service Provider describes both “Access Providers” such as infrastructure-based operations (Multiple System Operators), and “Content Providers” that supply and manage the ingress of media objects, products and/or non-access services within the Signature ID system.

Subscriber: A subscriber is an individual person, who can be a consumer or producer of assets (or both). A subscriber has one Registrar and one Content Authority. Since a subscriber's Registrar is most likely determined by their geographic location and/or their Service Provider, a mechanism for “transferring” preferences, attributes, and other demographic data about the subscriber between Registrars is provided.

Multi-Media Communication Network Examples

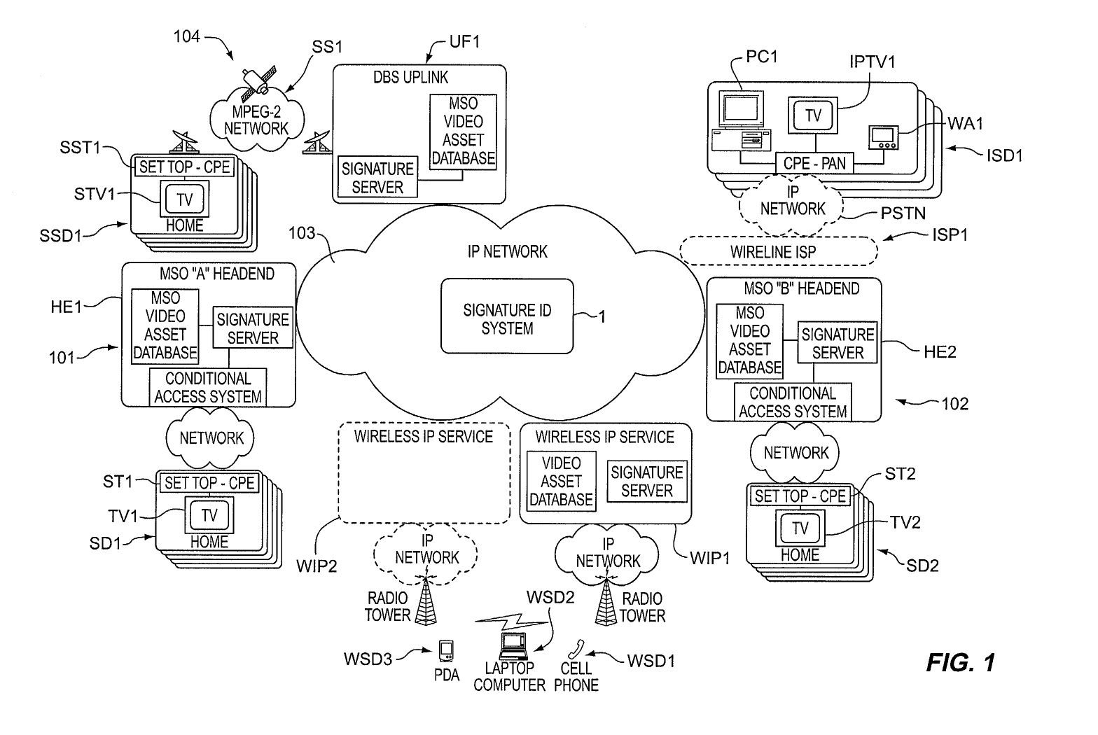

FIG. 1 illustrates in block diagram form the overall architecture of the present system for uniquely identifying assets and subscribers in a multi-media communication network and various environments in which it is operational. This view of multi-media communication networks is at a conceptual level, where the specific implementation details are omitted for the sake of clarity. A typical multi-media communication network comprises a plurality of physical elements to implement the communication medium and its associated signal distribution control system. These functions are simply illustrated as the “Network” that interconnects and serves subscriber devices and program sources.

Examples of such multi-media communication networks include a Cable Television Network 101, 102 that interconnects a plurality of subscriber devices, such as SD1, SD2, each comprising a television set TV1, TV2 and its associated “set top box” ST1, ST2, with the program source comprising a Multiple System Operator head-end HE1, HE2 that receives program content from various sources and delivers the program content to subscribers via a plurality of concurrently broadcast channels. The Multiple System Operator head-end HE1, HE2 typically includes a Video Asset Database and a Signature Server, which are components of the present system for uniquely identifying assets and subscribers in a multi-media communication network, as described herein. The Multiple System Operator head-end HE1, HE2 is also shown as interconnected with IP Network 103. A Satellite Television Network 104 interconnects a plurality of subscriber devices SSD1, each comprising a television set STV1 and its associated “set top box” SST1, with the program source comprising a Multiple System Operator uplink facility UF1 that receives program content from various sources and delivers the program content to subscribers via a satellite system SS1 that transmits a plurality of concurrently broadcast channels. The Multiple System Operator uplink facility UF1 typically includes a Video Asset Database and a Signature Server, which are components of the present system for uniquely identifying assets and subscribers in a multi-media communication network, as described herein, and is also shown as interconnected with IP Network 103. Another multi-media communication network comprises a wireline IP Service Provider ISP1 that interconnects subscriber devices ISD1, such as personal computers PC1, IP Televisions IPTV1, other appliances WA1, with a program source via the Public Switched Telephone Network PSTN. The IP Service Provider ISP1 may provide program content or simply interconnect the subscriber device with an entity, also served by IP Network 103, that contains the program content. A variation of the wireline IP Service Provider ISP1 is a wireless IP Service WIP1, WIP2 that interconnects portable subscriber devices, WSD1-WSD3 such as cellular telephones WSD1, personal computers WSD2, PDAs WSD3 and the like, with a program source via the Cellular Telephone Network. The wireless IP Service Provider ISP1, ISP2 may provide program content or simply interconnect the subscriber device with an entity, also served by IP Network 103, that contains the program content. The wireless IP Service Provider ISP1, ISP2 typically includes a Video Asset Database and a Signature Server, which are components of the present system for uniquely identifying assets and subscribers in a multi-media communication network, as described herein.

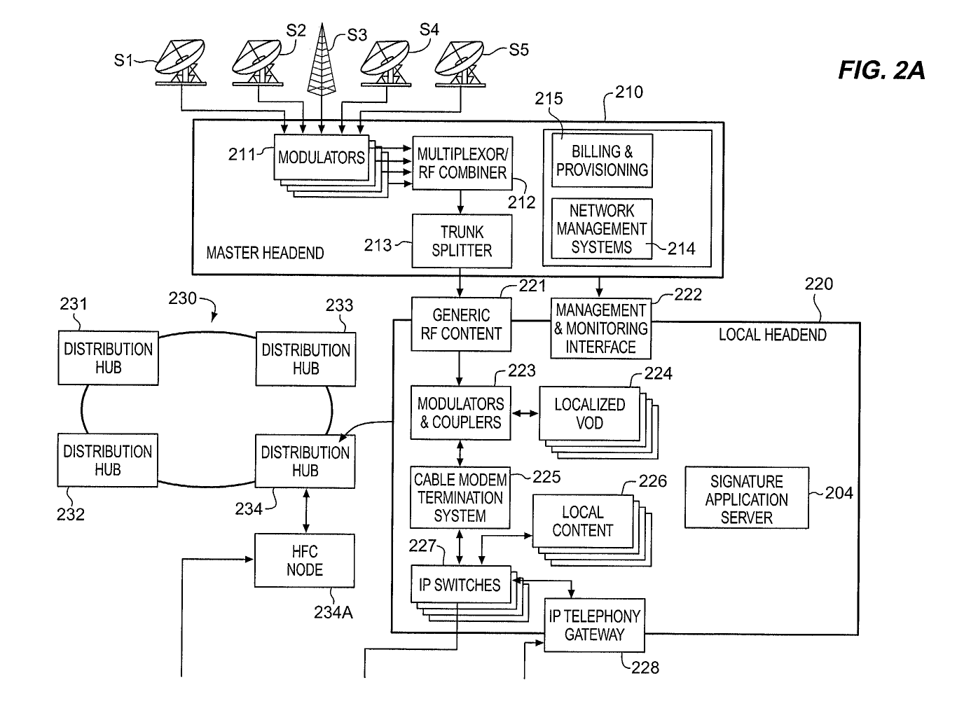

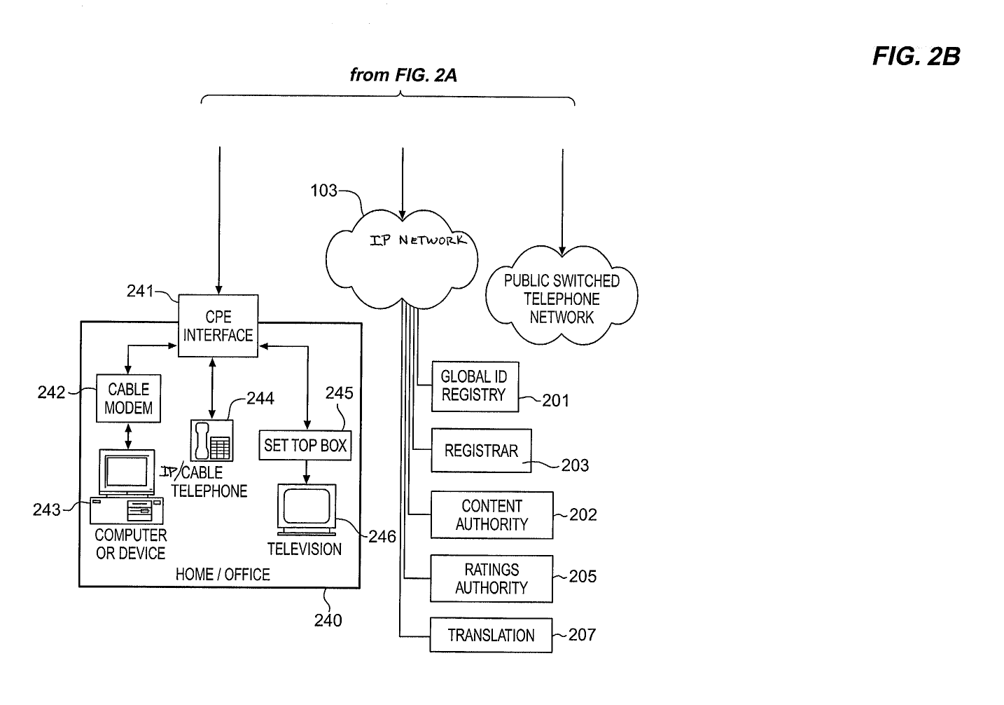

Connected to the multi-media communication networks, either directly or via the Internet 103, are a plurality of elements that operate to implement the present system for uniquely identifying assets and subscribers in a multi-media communication network (“signature ID system”) 1. These elements include a registration system component that functions to authorize the registration of subscribers and/or assets and assign their respective unique identification. In addition, the content authority system component uses the subscriber identifier and asset identifier to determine whether a subscriber is authorized to access assets, and to initiate the delivery of that asset to the subscriber via a communication medium, shown in additional detail in FIGS. 2A & 2B.

Global Identification Registry (GIR)

Coordination amongst the various service providers, users, licensors, and other service entities is essential to the function of the overall system. The Global Identification Registry 201 is the apparatus that provides the functional processes necessary for such coordination. First and foremost, the Global Identification Registry 201 is the entity charged with governing the interactions between service providers, users, licensors, and other service entities involved with the system. Definition of interactions between entities and any misunderstandings or disputes that arise from such interactions are ultimately referred to the Global Identification Registry 201 for resolution. The Global Identification Registry 201 is also responsible for assigning identification numbers to sub-entities such as Content Authorities 202 and Registrars 203. This function may involve a review process, where applicants are compared to a defined set of criteria to determine their eligibility for entity status. The Global Identification Registry 201 also has authority to revoke status to an entity that fails to conform to the standards and/or guidelines set forth by the Global Identification Registry 201.

Registrar

A Registrar 203 is an apparatus for conveyance of registration information about a particular asset, user, or other object. Using standards and guidelines set forth by the Global Identification Registry 201, a Registrar 203 is an entity that takes on the responsibility of operating and maintaining a database of registrations and making that information accessible to other Registrars and entities that interact with objects throughout the system. In its simplest embodiment, a Registrar 203 operates and maintains a registration database for objects that it owns, controls, or represents. Another embodiment provides for a Registrar 203 to act as a “proxy” for other organizations that desire their objects to be registered, but they do not which to perform the Registrar function themselves.

In some cases, a Registrar 203 may specialize in a topic area or style to meet business or consumer need. For example, a Registrar 203 may choose to specialize in educational materials for children, in which case it may develop highly customized methods for classification that ensure that appropriate content is delivered to a pre-defined set of children's age groups.

Signature Server

The Signature Server 204 is an apparatus that receives requests for service from a subscriber and verifies the subscriber's authorization to receive the requested service. The Signature Server 204 controls the metadata that defines the various assets and uses the metadata to share content among systems, such as among Multiple System Operators. The subscriber's access to assets is determined by the Signature Server 204, as is the retrieval of assets that are defined by the metadata contained in a product, such as a program.

Content Authority

The Content Authority 202 provides a system/service for Subscribers to purchase, package services (like a long-distance company or cable company) and/or settle payments for third-party products, separate from the Access service. The Content Authority 202 may be an independent entity, or it may be a part of a Service Provider.

Ratings Authority

A Ratings Authority 205 is an entity that promotes a standardized method for rating content and its appropriateness for particular classes of Subscribers. A Ratings Authority 205 may be an independent entity that serves one or more Content Authorities 202 or Service Providers, or it may be a function of a Content Authority 202 or a Service Provider. For simplicity of description, the Ratings Authority 205 is illustrated as a component of the Content Authority 202.

RMI Server

The RMI Server 206 performs two main functions for the Signature Application Server (SAS) 204. The first function is to provide a link between Signature Application Servers 204. The second is to provide an abstracted interface to the database(s) that store the metadata for content as well as user and project data.

The first function, intra-RMI Server traffic, allows for content sharing between Signature Application Servers 204. This content sharing may be in the form of meta-data about a presentation such as a video greeting card, binary data sharing such as images or videos, and lookup information such as determining the Ratings Authority 205 of a piece of content authored in the particular Signature Application Server 204. The second function, database(s) abstraction provides an interface to data stored in the database(s) that does not require any knowledge of the database(s) that is storing the data and does not require any knowledge of SQL programming. This allows pipeline developers to create pipelines that are not dependent upon a particular database so that they can write code one time and have it work on all Signature Application Servers 204.

In summary, the RMI Server 206 can be viewed as a gateway for all content between Signature Application Servers 204 as well as an interface for publishing and viewing all information about a presentation.

Translation—Transcoding

In a multi-media communication network, and in particular where communications between subscribers and/or between a subscriber and a content source spans multiple multi-media communication networks, the original asset may need to be reformatted or translated. This is to account for the differences in capabilities of various subscriber devices as well as differences in capabilities of the communication media that are used to serve the subscribers. Therefore, a Translation—Transcoding module 207 can be provided to effect this conversion of program content. The translation—Transcoding module can be implemented in the RMI Server 206 or can be a separate entity available to the multi-media communication network.

Cable Television Network Embodiment

FIGS. 2A & 2B illustrate in block diagram form a specific implementation of the present system for uniquely identifying assets and subscribers in a multi-media communication network in a cable television environment. The example used here is equally applicable to any multi-media communication network and the operation of the present system for uniquely identifying assets and subscribers in a multi-media communication network spans multiple types of multi-media communication networks. Thus, the underlying concept is the linking of a uniquely identified subscriber with a selected uniquely defined asset. In the present example, the simple case of a subscriber creating a video greeting card and transmitting the completed video greeting card to a selected recipient is used to illustrate the underlying concepts of the present system for uniquely identifying assets and subscribers in a multi-media communication network.

As shown in FIGS. 2A & 2B, a typical Cable Television System includes a Master Head-End 210 that receives program content from multiple sources S1-S5, typically via satellite transmission or microwave transmission, and interconnects the received program content to a plurality of trunks that carry the program content in radio frequency format to multiple local head-end systems, such as 220. The received radio frequency signals are modulated 211, multiplexed 212 and then split 213 into discrete channels. The program content is typically a continuous feed of individual programs broadcast on a predetermined time-of-day schedule and may include segments that are devoid of program content in order to enable the local head-end systems to insert their own local programming or local advertising. The operation of such a system is well-known in the art and is not described in detail herein and includes various administrative and program management elements, such as billing & provisioning 214 and network management systems 215.

The radio frequency program content as received at the local head-end system 220 can be combined with a plurality of other content, such as: local content 226, video on demand 224, IP telephony 228, Internet data 227 and coupled to a distribution hub 234 which routes the signals from the local head-end system 220 to a plurality of local cable loops (via HFC node 234A) comprising coaxial cable or fiber optic cable, and optionally also to other distribution hubs 231-233 and their plurality of local cable loops, comprising coaxial cable or fiber optic cable. The local loops terminate at a subscriber premises 240 at an interface 241 where the received signals are interconnected with one or more subscriber devices, such as: a set top box 245 and its associated television 246, cable modem 242 and its associated personal computer 243, cable/IP telephone 244, and the like. The communication path between the subscriber devices 242-246 and the local head-end system 220 is bi-directional, with the predominant portion of the available bandwidth being used in the downlink direction to the subscriber device 242-246 from the local head-end system 220. The local head-end system 220 as noted above can be a repository of assets that are referenced via metadata and available to subscribers regardless of their location. In operation, the assets, such as a movie stored in video on demand system 224, are not removed from storage but are “transmitted” via the distribution of metadata that defines the location of the asset. The access to an asset is accomplished by using the metadata that points to the asset at the time of retrieval, to obtain a copy of the asset. This process ensures that multiple copies of an asset are not present on the system unless necessitated by data bandwidth and pre-caching concerns.

The local head-end system 220 may be equipped with or connected to a Signature Server 204. The local head-end system 220 is also shown as connected to IP Network 103. A Registrar 203 and Content Authority/Ratings Authority 202/205 are shown as connected to the Local Head-End 220 via IP Network 103. The location of these components as shown is simply illustrative and is not intended to limit their applicability in terms of being integrated into various components of the multi-media communication network, or their particular combinations and locales within the multi-media communication network.

Video Card Example

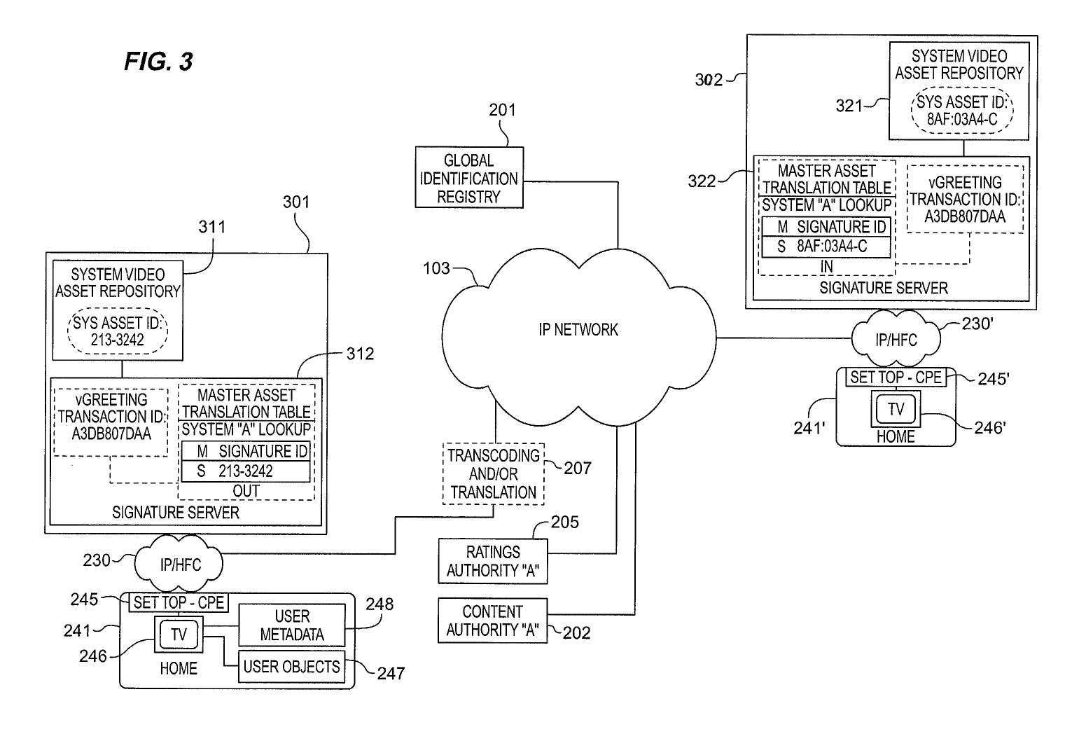

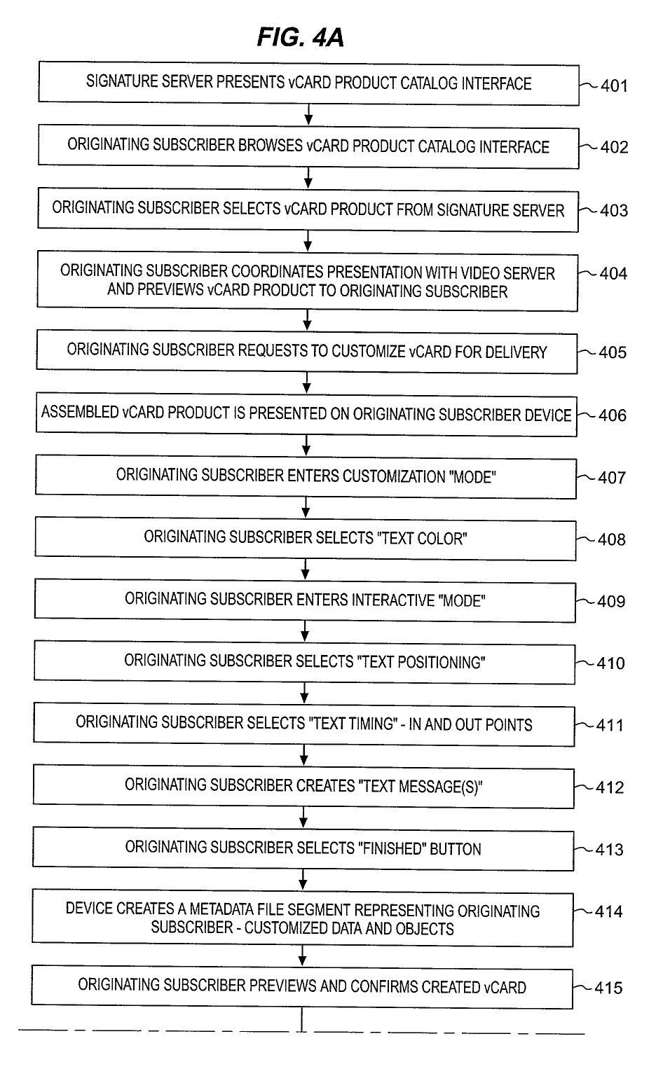

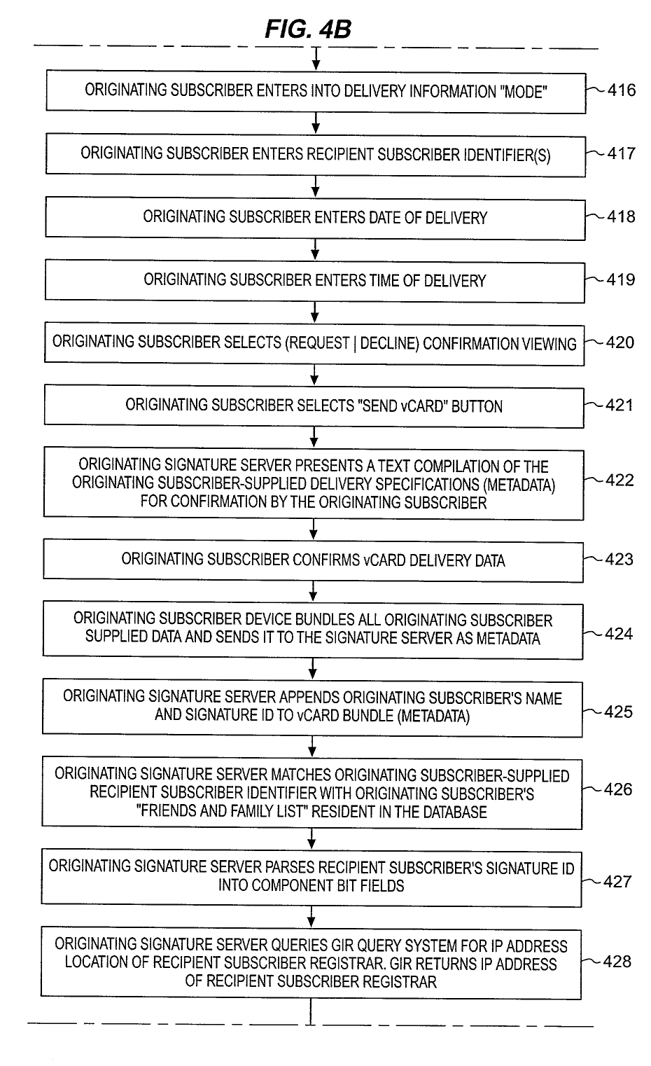

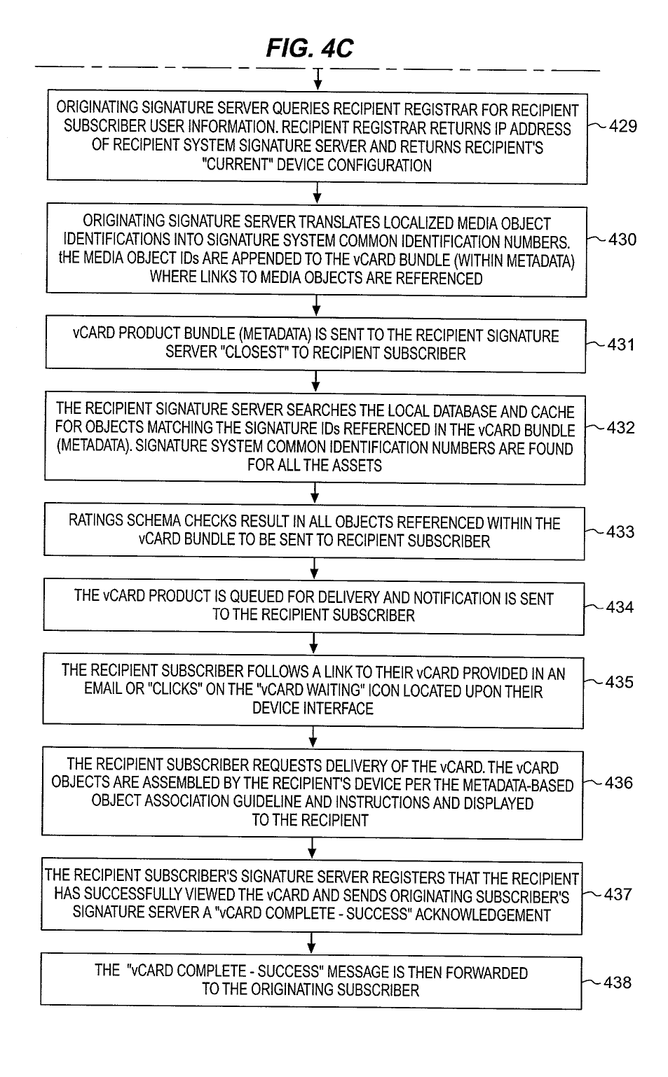

FIG. 3 illustrates a simplified view of FIGS. 2A & 2B to show the operation of the signature ID system 1 in a Cable Television environment and FIGS. 4A-4C illustrate in flow diagram form the operation of the signature ID system 1 to serve a subscriber request for transmission of a selected multi-media asset to a selected destination. The example of the creation and transmission of a video greeting card (termed “vCard” herein) is used herein.

This example makes use of a Signature Server 312 that is available to provide video greeting services to the subscriber. This Signature Server 312 can be located, using the Cable Television Network in the above example, at the Local Head-End 301. The Signature Server 312 has access to video assets that are either stored in a local video asset repository 311 or in any other asset repository, such as video asset repository 321 on Local Head-End 312. Other assets that are available for use in creating a vCard can be user objects 247 stored at the subscriber's location or subscriber metadata 248, also stored at the subscriber location, that identifies assets that are defined by the subscriber, but located elsewhere and accessible by the Signature Server 312 for the creation of the vCard.

vCard Browse and Preview

At step 401, the subscriber, located at subscriber premises 240 initiates the vCard creation process by executing a login, permissions check and account status check to access the Signature Server 312, which includes the functionality that provides a vCard service. In particular, the Signature Server 312 includes a vCard process that assigns a vCard transaction ID, such as the code “A3DB807DAA” shown in FIG. 3. The vcard process presents the Originating Subscriber located at subscriber premises 240 with a vCard Product Catalog Interface. The vCard Product Catalog Interface is a phrase used herein to describe the functionality that is provided by Signature Server 311 to enable the subscriber to interact with the Signature Server 311 in the vCard process. The present typical implementation of such an interface is a series of screen displays and menus that enable the Originating Subscriber to navigate through a plurality of selections to login, select, customize, order and transmit a vCard to a selected recipient (termed “Recipient Subscriber” herein).

It should be noted that the unique identification of the Originating Subscriber provided by the Signature ID assigned to that subscriber can be mapped to a subscriber profile maintained in the Signature Server 311 and/or the Content Authority. The subscriber profile can define the characteristics of the subscriber device as well as the usage characteristics of the subscriber. In this instance, the Master Asset Translation Table uses the Originating Subscriber's Signature ID to associate the vCard Transaction ID with the assets used to implement the vCard, such as the asset identified by the tag “213-3242” in FIG. 3.

At step 402, the Originating Subscriber browses the vCard Product Catalog Interface to locate a vCard selection, typically stored in System Video Asset Repository 311 of Local Head-End 301. The Originating Subscriber, at step 403, selects a vCard product from System Video Asset Repository 311 by indicating their choice to Signature Server 312 via the appropriate screen display provided by the vCard Product Catalog Interface. At step 404, Originating Signature Server 312 coordinates the subscriber-selected presentation with Video Server (such as a personal computer or television) and previews the selected vCard product to the Originating Subscriber. At step 405, the Originating Subscriber requests Signature Server 312 to customize the selected and previewed vCard, such as the asset identified by the tag “213-3242” in FIG. 3, for delivery to a Recipient Subscriber.

vCard Select and Customization

The vCard selection and customization process is initiated at step 406, where the assembled Originating Subscriber selected vCard product (comprising a combination of elements, such as: Audio, Video, Code Objects, User Customization Objects, Sub-Sys interaction Objects, Buttons) is presented on the Originating Subscriber's device 246. At step 407, the Originating Subscriber enters the Customization “mode” (screen) within the selected vCard product and at step 408 the Originating Subscriber selects, for example, “Text Color” from the choices presented therein. At step 409, the Originating Subscriber enters an Interactive “mode” which enables the subscriber to implement their selected vCard product customization while the Signature Server 312 is displaying the selected vCard product. For example, the Originating Subscriber selects “Text Positioning” at step 410 and “Text Timing”—In and Out points at step 411. At step 412, the Originating Subscriber creates “Text Message(s)” where the Originating Subscriber can input a personalized message to accompany the vCard. At step 413, the Originating Subscriber selects the “Finished” button when the customization of the selected vCard is complete.

At step 414, the subscriber device 246 creates a metadata file segment representing Originating Subscriber-customized data and objects. The Originating Subscriber at step 415 previews and confirms the customized vCard (selected vCard as combined with subscriber created text object and metadata).

vCard Delivery Data Specification

Since the Originating Subscriber has completed the vCard product selection process, the delivery of the vCard must be defined by the Originating Subscriber. At step 416, the Originating Subscriber enters into the Delivery Information “mode” within the vCard Product, where at step 417 the Originating Subscriber enters Recipient Subscriber Identifier(s) (UserID|PIN_ID|Name|SignatureID) into a Delivery Form Component of the vCard Product. At step 418, the Originating Subscriber enters Date of Delivery into the Delivery Form Component of the vCard Product and at step 419, the Originating Subscriber enters Time of Delivery into Delivery Form Component of the vCard Product. This Originating Subscriber provided data defines the delivery attributes for the vCard product. The Originating Subscriber can at step 420 select (Request|Decline) Confirmation of Viewing option on the Delivery Form Component of the vCard Product. Once these selections have been completed, at step 421 the Originating Subscriber selects “Send vCard” button on Delivery Form Component of the vCard Product.

vCard Generation

The Originating Subscriber, in creating a customized vCard, assembles a compilation of data elements which, when integrated, comprise the vCard product that is delivered to the Recipient Subscriber. The data elements are characterized by metadata (such as the asset tag “213-3242”), so the original data elements (stored in system video asset repository 311) are immutable and a copy of these data elements are created for integration into the final vCard product at the time of delivery. Thus, at step 422, the Originating Signature Server 312 presents a text compilation of the Originating Subscriber-supplied Delivery Specifications (Metadata) for confirmation by the Originating Subscriber to ensure the accuracy and completeness of the vCard product. At step 423, the Originating Subscriber confirms the displayed vCard delivery data or returns back to the Delivery Form Component of the vCard Product at step 416. When the Originating Subscriber confirms the Delivery Specification Data, at step 424, the Originating Subscriber Device 426 bundles all Originating Subscriber supplied data (product customization and delivery specification) and sends it to the Signature Server 312 as metadata. This metadata also includes the Subscriber-created Text Object.

vCard Transaction Generation

The transmission of the vCard product is accomplished at step 425 where the Originating Signature Server 312 appends Originating Subscriber's Name and Signature ID to the assembled vCard Bundle (Metadata). At step 426, the Originating Signature Server 312 matches the Originating Subscriber-supplied Recipient Subscriber Identifier with the Originating Subscriber's “Friends and Family List” resident in the database in the Signature Server 312. The Originating Signature Server 312 parses Recipient Subscriber's Signature ID into component Bit fields at step 427 and at step 428, the Originating Signature Server 312 queries the Query System located in the Global Identification Registry 301 for IP Address location of Recipient Subscriber Registrar. The Global Identification Registry 301 returns the IP Address of Recipient Subscriber Registrar and at step 429, the Originating Signature Server 312 queries the Recipient Registrar for Recipient Subscriber User Information. The Recipient Registrar returns IP Address of Recipient System Signature Server 322, returns Recipient's “current” device configuration. At step 430, the Originating Signature Server 312 translates localized Media Object (Video, Audio, etc) identifications into Signature System Common Identification Numbers (if assets reside in MSO database and Asset Servers for instance and are not managed or controlled directly by Signature Servers). This allows Recipient Signature Servers to identify local copies of the Media Assets, regardless if they are labeled with a localized method. The Media Object Signature IDs are appended to the vCard bundle (within Metadata) where there are links to Media Objects are referenced.

vCard Metadata Transport and Transaction Exchange

The physical delivery of the vCard product is effected at step 431, where the vCard Product Bundle (Metadata) is sent (“PUSHED”) to the Recipient Signature Server 322 that is “closest” to the Recipient Subscriber (per the queries made to Recipient's Registrar). This is shown as the entries in Master Asset Translation Table 322 in Local Head-End 302 in FIG. 3.

Object Check and Recipient Notification

At step 432, the Recipient Signature Server 322 searches the local Database & Cache for Objects matching the Signature IDs referenced in the vCard Bundle (metadata). Signature System Common Identification Numbers are found for all the assets. At step 433, the Ratings Schema checks result in all Objects referenced within the vCard bundle to be sent to Recipient Subscriber. In response to this verification process, at step 434 the vCard Product is queued for delivery and notification is sent to Recipient Subscriber. This notification can be made via an Email message (queried from the Recipient's Database record in Registrar DB) with a link to the vCard “Product Gateway” or by a system-prompted code object that pushes a “vCard Waiting” icon to the Recipient Subscriber's Device interface.

vCard Delivery and Assembly

The vCard product retrieval process is a “pull” process where the Recipient Subscriber activates their Signature Server 322 to initiate the retrieval process. The Recipient's Signature Server 322 uses the metadata that defines the deliverable product, a vCard in this case, to locate and retrieve the data elements that are identified by the metadata entries in the vCard product definition. The Recipient Subscriber initiates the vCard retrieval and display process at step 435 when the Recipient Subscriber follows a link to their vCard provided in an email or “clicks” on the “vCard Waiting” icon located upon their device interface. At step 436, the Recipient Subscriber requests delivery of the vCard, created by the Subscriber. The vCard Objects (including the Originating Subscriber Generated Text Object) are assembled by the Recipient's Device per the Metadata-based object association guidelines and instructions and displayed to the Recipient.

vCard Receipt Confirmation

If the Originating Subscriber has requested delivery confirmation, then at step 437 the Recipient Subscriber's Signature Server registers that the Recipient has successfully viewed the vCard and sends the Originating Subscriber's Signature Server a “vCard Complete—Success” acknowledgement. At step 438 the “vCard Complete—Success” message is then forwarded to the Originating Subscriber if requested in step 420.

Typical Signature Identification Format

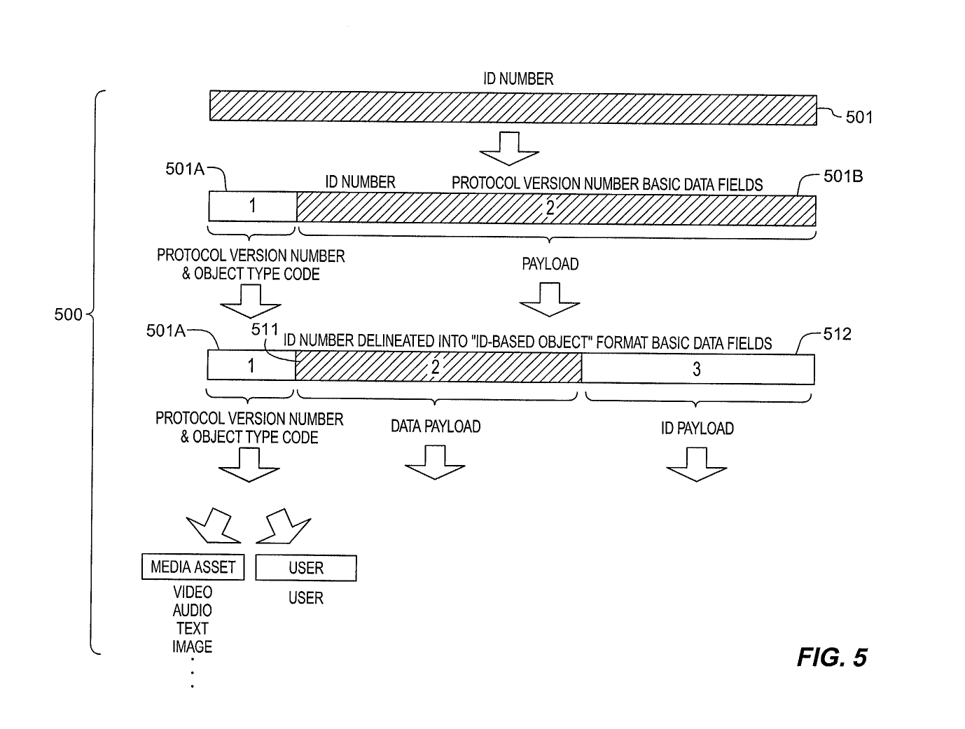

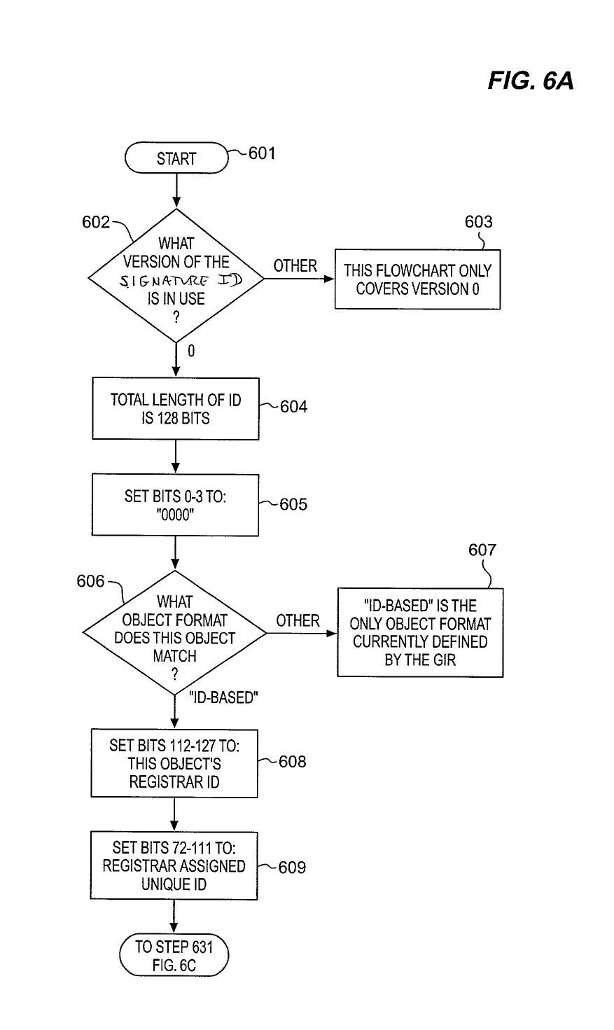

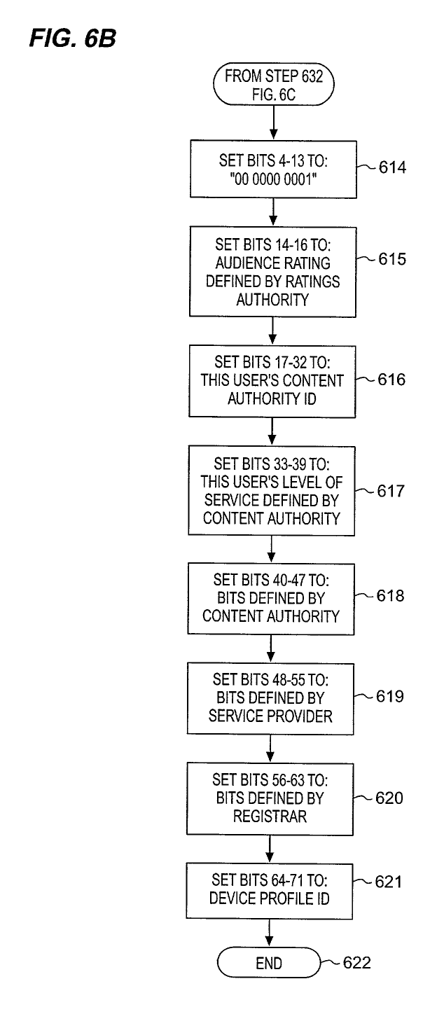

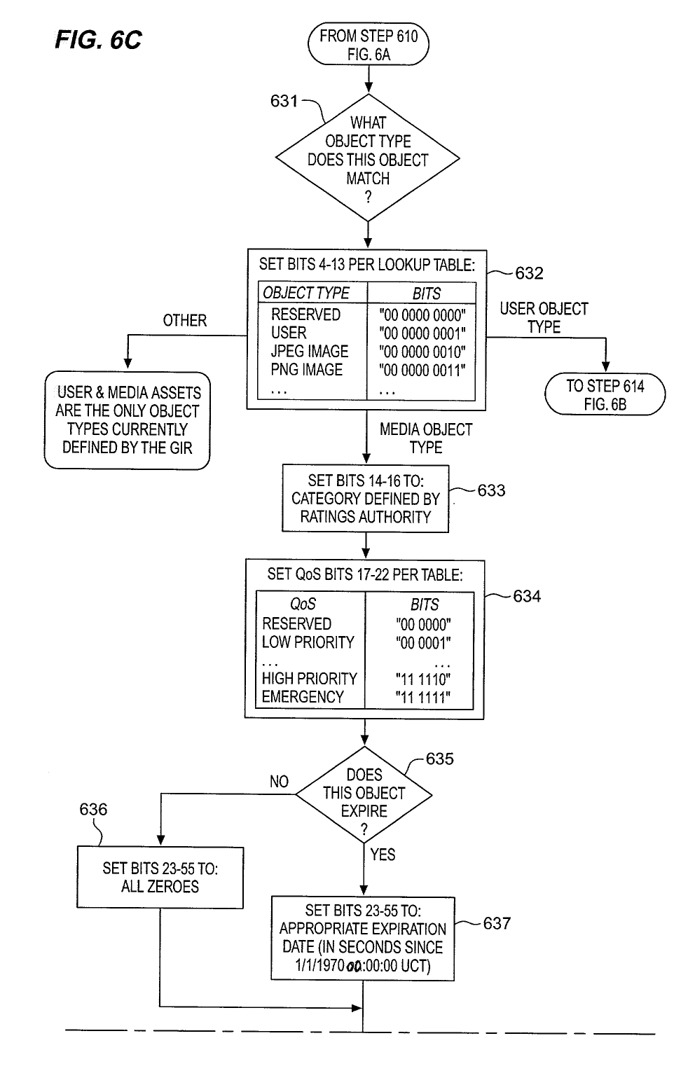

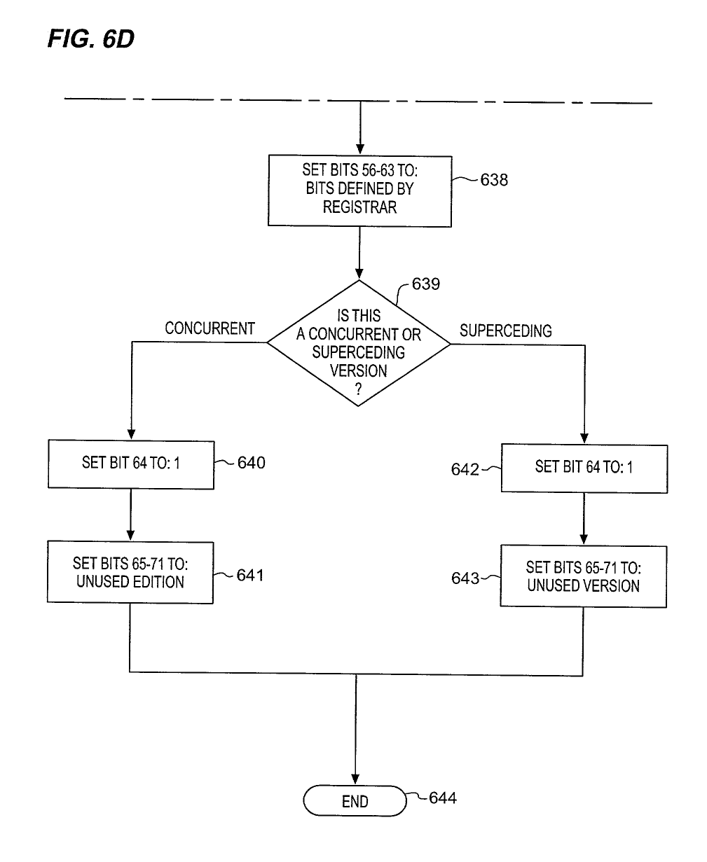

FIG. 5 illustrates a typical format of a signature identification format 500 for both subscribers and multi-media assets for use in the present system for uniquely identifying assets and subscribers in a multi-media communication network and FIGS. 6A-6C illustrate in flow diagram form the operation of the registration system component 203 of the present system for uniquely identifying assets and subscribers in a multi-media communication network to assign an unique signature identification to an object.

Protocol Specification

There is a benefit to use identical length fixed-length identifiers for both assets and subscribers and 128 bits is used herein as an example of typical identification numbers that are architected for use on a world-wide, highly-distributed basis. A hierarchical design is adopted within this specification as the most extensible and scalable method of representing information, events, media objects, product data and transaction data.

Protocol Definitions

Quality of Service, is a conceptual abstraction used to indicate various grades of desired or delivered performance. The higher the quality of service value, the higher the expected or realized performance at the subscriber's site in that this is not necessarily a linear relationship, this is only a differentiating value.

Object Format: The highest-level in the hierarchy of object organization within the Signature ID specification, the Object Format is a broad classification of objects which share similar functional needs for identification.

Object Template: Below Object Format in the object organization hierarchy, an Object Template specifies the structure used to describe a broad category of objects (e.g., Media Assets). Object Templates are used to group identification and payload abstraction concepts.

Object Type: At the lowest level of the object organization hierarchy, an Object Type is a narrow specification of an object. Objects within the same object type exhibit the same basic categorical and behavioral parameters. The description of every field within the Signature ID specification is known once the Object Type is known.

Inherited Authority Relationships: In addition to utilizing direct entity authority relationships within this document, there are two inherited authority relationships. Non-direct authority relationships result due to the hierarchal inheritance of fields from a Version Specification, through a Format Specification, to Template Specifications.

Protocol Version: identifies the Version Specification as the level of Specification, at which the field was delineated from the Signature ID.

Object Format: identifies a Format Specification (ID-based Object Format) as the level of Specification, at which the field was delineated from the Signature ID.

Object Template: identifies a Template Specification (Object Template Specification: Media Asset) as the level of Specification, at which the field was delineated from the Signature ID.

Specific Fields

Fields 1 and 2, as shown in Tables A-C, combine to form the Protocol Version/Object Type Code component 501A of the Signature ID 501. A number represented within Field 2 (in this embodiment) represents a single Object Type Code. The 114 bits available within Field 3 (Payload) 501B are further delineated and defined in Table D through the hierarchal specification of Object Formats, Object Templates and Object Types.

TABLE A

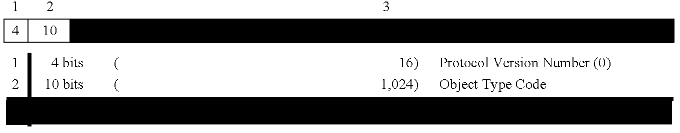

TABLE B

| Field | Bits | Authority | Bit-range Name |
|---|---|---|---|
| 1 | 4 | GIR | Protocol Version Number |

Definition:
The first four bits designate the Signature ID Protocol Version Number. This version number is intended to allow major revisions to the basic size and/or structure of the Signature ID Protocol. The Global Identification Registry may publish new versions of the Protocol specification. Ideally, this version number should change rarely, if ever.

TABLE C

| Field | Bits | Authority | Bit-range Name |
|---|---|---|---|
| 2 | 10 | GIR | Object Type Code |

Definition:
Field 2 contains a ten-bit Object Type Code, standardized by the Global Identity Registrar and set by a Registrar. Object codes are used to identify individual Object Types and specify the use of the 114 bits after Field 2, as well as to pass implicit information about an object such as QoS, storage, and display requirements (Data Payload).
Presently, there are two documented Object Templates under the ID-based Number Format. The “Subscriber” Template Specification details a single Object Type. The “Media Asset” Template Specification details multiple Object Types defined and specified thus far: “Reserved” Object Type, Subscriber Object type Media Asset Object type, consisting of “Image”, “Text”, “Video” and “Audio.”

TABLE D

| Field | Bits | Authority | Bit-range Name |
|---|---|---|---|
| 3 | 114 | Object Format Specification | Payload |

Definition:
The remaining 114 bits of the Signature ID are specified by Object Format (ID-based or Non-ID-based Object), and then Object Template or Object Type specifications.

### Object Format Classification and Process

Object Formats: ID-Based Objects

Within the specification process, the hierarchal approach has been useful in assisting in the process of sub-categorization of Object Templates and Types as shown in Table E. For illustrative purposes, one “high-level” Object Format has been specified: The ID-Based Object. By specifying a group of Objects as “ID-Based Objects,” we can assign a second level of field commonality to Object groupings (in this case, designating 5 common fields rather than the two assigned under the Protocol Version Number specification).

TABLE E

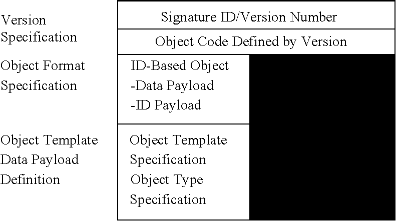

As the label states, all Object Templates and Types defined under the Object Format “ID-based Objects” will have five common fields. The first two fields, as noted above and as shown in Tables G & H, under the Version 0 Specification, the third field represents the Data Payload and the last two fields are ID payload-related fields. Non-ID-based Objects remain “UNDEFINED” as of the writing of this document.

The five ID-Based Object fields are represented within Table F:

TABLE F

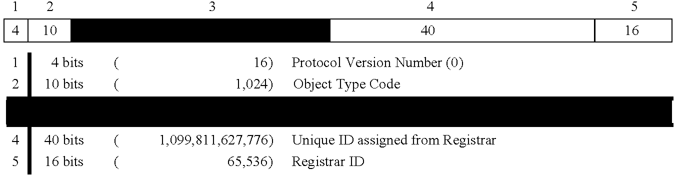

Within the Object Specification process, Object Templates may be utilized to simplify the creation and standardization of Object types that require/share the same Data payload information in the definition process. Field 3 shown in Table I is the Data Payload field, the 58-bits of data contained here, gain significance from Object Template or Object Type specification. Fields 4 and 5 shown in Tables J & K combine to form the ID Payload Component of the Signature ID.

TABLE G

| Field | Bits | Authority | Bit-range Name |
|---|---|---|---|
| 1 | 4 | Protocol Version | Protocol Version Number |

Definition:
The first 4 bits of the ID designate the Protocol Version number. This component is defined within the Version Specification portion of this document.

TABLE H

| Field | Bits | Authority | Bit-range Name |
|---|---|---|---|
| 2 | 10 | Protocol Version | Object Type Code |

Definition:
The second 10 bits of the ID, specified within the Version 0 Specification portion of this document, designate the Object Type described by the complete Signature ID.

TABLE I

| Field | Bits | Authority | Bit-range Name |
|---|---|---|---|
| 3 | 58 | Object Template | Data Payload |

Definition:
The 58-bit range between the first 14-bit Grouping (Protocol Version Number/Object Type Code) and the end 56-bit Grouping (The ID Payload Component) is defined as the Data Payload component of the Signature ID within the ID-based Number Format specification.
Data Payload specifications may be shared among a number of Object Types, defined under an Object Template grouping, or they may be utilized in a unique manner by a single Object Type under an object Template.

TABLE J

| Field | Bits | Authority | Bit-range Name |
|---|---|---|---|
| 4 | 40 | Registrar | Unique ID |

Definition:
This 40-bit field is a unique asset identifier that is set by a Registrar. The Registrar is responsible for ensuring that the algorithm used for populating this field always produces a unique 40-bit value (unique to that Registrar).
Given the requirement that Field 5 (described below) represents a unique Registrar number, and the requirement that this field be unique within the individual Registrar, Fields 4 & 5 combined provide a globally unique 56-bit identification number used to identify the object, entity or action specified by the Object Type Code.

TABLE K

| Field | Bits | Authority | Bit-range Name |
|---|---|---|---|
| 5 | 16 | GIR | Registrar Identity |
| Definition: | | | |
| This 16-bit field holds a number, set by the Global Identification Registry (GIR), that uniquely identifies each Registrar entity that is authorized to assign Unique ID Numbers (Field 4). The GIR is responsible for ensuring that algorithm used when assigning Registrar numbers always produces a unique 16-bit number. A Registrar may be a single Content-Producing entity, an access providing entity or it may be an entity that represents and/or provides registry services | | | |
| # to a multitude of entities. | | | |

Example of Use:
The GIR can choose any scheme for allocating registrar IDs. Registrars that exhaust their 40-bit allocation space would probably be assigned an additional registrar ID.

Object Template Specification: Media Asset

Table L illustrates the content of the Object Template portion of the Data Payload for a media asset. Tables M-T detail typical definitions for the fields that are used to implement the Object Template.

TABLE L

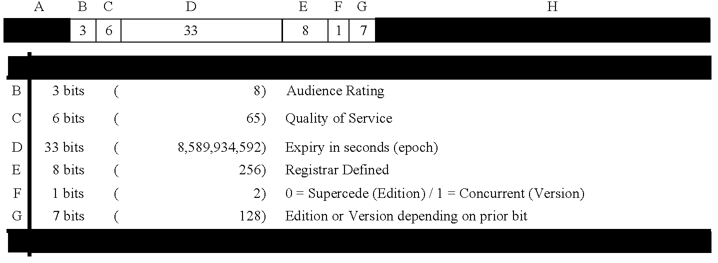

Media Asset—Data Payload:

TABLE M

| Field | Bits | Authority | Bit-range Name |
|---|---|---|---|
| A | 14 | Version | Protocol Version Number/Object Type Code |

Definition:
The first 14 bits of the ID designate the Protocol Version Number/Object Type Code. This component is defined by fields 1 and 2 within the Version Specification portion of this document.

TABLE N

| Field | Bits | Authority | Bit-range Name |
|---|---|---|---|
| B | 3 | Ratings Auth | Audience Rating Category |
| Definition: | | | |
| Field B is a three-bit field that is defined and guaranteed by a Ratings Authority. A relationship between a Ratings Authority and a Registrar influences its use by the Registrar that sets the bits relevant to their own content. Each Registrar-Content Authority relationship utilizes its own scheme for defining how these bits best represent different audience categories. However, this field is mutable by Service Providers, who can modify Field B to capture audience information pertinent | | | |
| # to their subscribers. As assets travel between various content networks, each service provider may adjust Field B appropriately. Externally defined relationships between service providers could provide a mechanism for dynamically translating Field B between networks. | | | |

TABLE O

| Field | Bits | Authority | Bit-range Name |
|---|---|---|---|
| C | 6 | GIR | “Quality of Service” |

Definition:
This six bit range is set by the Registrar to specify specific QoS related information about an asset or media object. This field influences the behavior and management of asset types by a server, through a network environment, or by a device.

TABLE P

| Field | Bits | Authority | Bit-range Name |
|---|---|---|---|
| D | 33 | GIR | Expiry (represented in seconds) |

Definition:
This 33-bit range is set by Registrars (and their subscribers) for explicitly declaring the length of time the individual asset resides within network caching devices and/or subscriber device caches before a new instance of the asset is required to be retrieved from the Registrar's/Content owner's server.
Example of Use:
The UNIX command date (date +%s) can be used to determine the number of seconds elapsed from the epoch (00:00:00 Jan. 1, 1970) to current time. There are subroutines that can be integrated within the asset upload/authoring tool to schedule an expressed or anticipated expiry date and time in GMT from human readable input.

TABLE Q

| Field | Bits | Authority | Bit-range Name |
|---|---|---|---|
| E | 8 | Registrar | Defined by Registrar |

Definition:
These bits, set by the Registrar, are reserved for the registrar to use. No one other than this subscriber's registrar needs to know the meaning of these bits although the registrar has the right to publicly disclose their significance for other applications to be able to make use of them.

TABLE R

| Field | Bit | Authority | Bit-range Name |
|---|---|---|---|
| F | 1 | GIR | Supercede/Concurrent Bit |

Definition:
This is the supercede/concurrent bit. Set by a Registrar, this bit is used to determine whether this asset is to replace or co-exist with other assets that share the same 56 bits specified within the ID Payload Component of a Signature ID. If “0” this asset supersedes all previous assets and if “1”, this asset is just another concurrent edition of the assets that share the same ID Payload.

TABLE S

| Field | Bits | Authority | Bit-range Name |
|---|---|---|---|
| G | 7 | GIR | Edition/Version Bits (defined by Field F) |

Definition:
These bits are incremented to represent a change in version or addition of an edition in reference to an original Asset ID Payload. If Field F is set to “0”, then this asset would supersede any assets that have the same ID Payload number but a lower value for Field F. If Field F is set to “1”, then this field represents an order for all assets sharing the same ID Payload as this one. This is useful for representing episodes in a series or other like applications.

TABLE T

| Field | Bits | Authority | Bit-range Name |
|---|---|---|---|
| H | 56 | Format | ID Payload |

Definition:
These last 56 bits of the ID designate the ID Payload. This component is defined by fields 4 and 5 within the “ID-Based Object Format” Specification portion of this document.

Object Template Specification: Subscriber

Table U illustrates the content of the Object Template portion of the Data Payload for a subscriber. Tables V-AD detail typical definitions for the fields that are used to implement the Object Template.

TABLE U

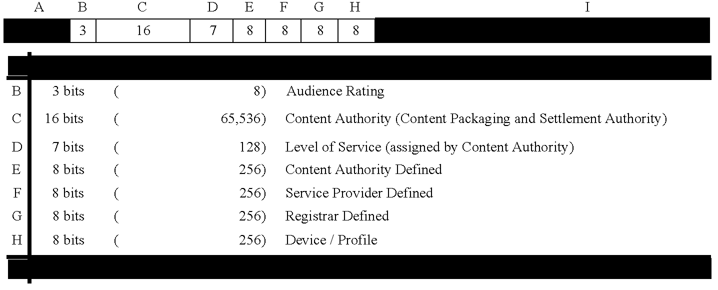

Subscriber—Data Payload:

TABLE V

| Field | Bits | Authority | Bit-range Name |
|---|---|---|---|
| A | 14 | Version | Protocol Version Number/Object Type Code |

Definition:
The first 14 bits of the ID designate the Protocol Version Number/Object Type Code. This component is defined by fields 1 and 2 within the Version Specification portion of this document.

TABLE W

| Field | Bits | Authority | Bit-range Name |
|---|---|---|---|
| B | 3 | Ratings Auth | Audience Rating Category |

Definition:
Field B is a three-bit field that is defined and set by a Subscriber's Ratings Authority. Each Ratings Authority uses their own scheme for defining how these bits best represent different audience categories. Externally defined relationships between Service Providers and Ratings Authorities could provide a mechanism for Service Providers to determine the relevance of the Field B bits between, Content Authorities and Service Providers.

TABLE X

| Field | Bits | Authority | Bit-range Name |
|---|---|---|---|
| C | 16 | GIR | Content Authority ID |

Definition:
This 16-bit range, set by the Global Identification Registry (GIR), is used by the GIR to assign Content Authority Identity Numbers to Content Authorities. A Content Authority will be a single authoritative entity which manages and settles Content relationships for subscribers.

TABLE Y

| Field | Bits | Authority | Bit-range Name |
|---|---|---|---|
| D | 7 | CA | Level of Service |

Definition:
This seven-bit range, allocated to the Content Authority (CA) by the Global Identification Registry (GIR), is defined and populated by the CA. The information represented within this field is relevant only within the Content Authority's own systems as a representation of the level of service that has been pre-defined for the subscriber represented by the whole Signature ID.
The Content Authority may select to use this field to represent a number (level of service) within a range (of 128 levels), or use the numbers to define different content packages or combination of content packages.

TABLE Z

| Field | Bits | Authority | Bit-range Name |
|---|---|---|---|
| E | 8 | CA | Content Authority Defined |

Definition:
These bits, set by the Content Authority, are reserved for the Content Authority to use. No one other than this subscriber's Content Authority needs to know the meaning of these bits although the Content Authority has the right to publicly disclose their significance for other applications to be able to make use of them.

TABLE AA

| Field | Bits | Authority | Bit-range Name |
|---|---|---|---|
| F | 8 | SP | Service Provider Defined |

Definition:
These bits, set by the Service Provider, are reserved for the service provider to use. No one other than this subscriber's service provider needs to know the meaning of these bits although the service provider has the right to publicly disclose their significance for other applications to be able to make use of them.

TABLE AB

| Field | Bits | Authority | Bit-range Name |
|---|---|---|---|
| G | 8 | Registrar | Registrar Defined |

Definition:
These bits, set by the Registrar, are reserved for the registrar to use. No one other than this subscriber's registrar needs to know the meaning of these bits although the registrar has the right to publicly disclose their significance for other applications to be able to make use of them.

TABLE AC

| Field | Bits | Authority | Bit-range Name |
|---|---|---|---|
| H | 8 | Registrar | Device Profile |

Definition:
These bits can be used to differentiate the subscriber's devices/profiles. This can be used to allow the subscriber to specify an ordering of preferred devices/profiles that they would like to receive content at by allowing them to change the order of the profiles.
Example of Use:
A Registrar (Service Provider) has a subscriber that uses more than one set top device or television set, the “Device Profile” Bit Range could be utilized by that Service provider to deliver specific services to one or several devices connected to their network and/or service in an emergency.
A Registrar (Wireless Service Provider) has a subscriber whom already has a Signature ID assigned to them from another Registrar (MSO). The Device Profile bits could be used by the Registrar to assign or defer preference for service requirements in relation to this subscriber's other ID Number.
A Registrar could also use this Bit Range to provide system level information that would direct the automation of ID Forwarding to a third-party Registrar.

TABLE AD

| Field | Bits | Authority | Bit-range Name |
|---|---|---|---|
| I | 56 | Format | ID Payload |

Definition:
These last 56 bits of the ID designate the ID Payload. This component is defined by fields 4 and 5 within the ”ID-Based Object Format” Specification portion of this document.

Registration Process

FIGS. 6A-6D illustrate the typical operation of a registration process. The process is initiated at step 601 and at step 602 the present version of the signature ID is determined, which in this case is shown as version 0, so step 603 is presently not implemented. With a version 0 signature ID, at step 604 the total length of the signature ID is set to be consistent with the definition of version 0 of the signature ID, which for this example is 128 bits. This is reflected in the signature ID itself by setting the first four bits to “0000” at step 605. At steps 606 and 607, the possibility of non-ID based signatures is provided, but presently not used.

The registrar's identity is now noted at step 608 where bits 112-127 are set to identify the registrar and the registrar then provides an unique object identification at step 609 by setting bits 72-111 to a new identification selected for this object as part of this registration process.

The selection of the object identification is performed at step 631 pursuant to a process defined by the registrar, which process can vary among registrars. The determination of object type drives step 632, where the bits 4-13 are set pursuant to a lookup table and the determined object type. For a user, the registrar sets bits 4-13 at step 614 to “00 0000 0001” as an example, to define the object as a user. The user and service provider provide information to define the next sequence of bits, with bits 14-16 being set by the Ratings Authority at step 615 to define an Audience Rating indicative of the type of program content desired by this user. The Content Authority selection is identified by bits 17-32 that are set at step 616. The particular Content Authority that is selected to serve this user sets the user's level of service at step 617 by bits 33-39 and can set bits 40-47 at step 618 for other administrative uses. The Service Provider is defined by bits 48-55 set at step 619 and the Registrar can set bits 56-63 at step 620 and define the user's device profile at step 621 by bits 64-71. This process then exits at step 622.

For a media asset, at step 631 the particular media type is selected and bits 4-13 set via use of a lookup table at step 632. The rating category as defined by the Ratings Authority is set at step 633 via bits 14-16 and a lookup table is used at step 634 to set the Quality of Service. Media objects are typically set to expire after a predetermined period of use so their signature IDs can be reused. This determination is made at step 635 and if the object is not scheduled to expire, bits 23-55 are set to a predefined code to reflect this choice. Otherwise, at step 637, these bits are set to identify a particular time when the media asset expires, based on the number of seconds that have elapsed from a predetermined point in time. Bits 56-63 are set by the Registrar and the nature of the media asset is determined at step 639 and if concurrent, bits 64 and 65-71 are set at steps 640 and 641, respectively to reflect this. If the media asset is superceding, bits 64 and 65-71 are set at steps 642 and 643, respectively to reflect this. This process then exits at step 644.

The signature ID set for this object is typically stored in a manner to correspond to the object where stored in memory so that the signature ID can be used to retrieve the uniquely identified object.

Summary

The present system for uniquely identifying assets and subscribers in a multi-media communication network assigns a unique and substantially self-identifying signature to every asset managed by the multi-media communication network as well as the subscribers who access the multi-media communication network. The signature ID system operates as an overlay on the multi-media communication networks to identify, facilitate and manage received individual subscriber requests and between and among subscribers, administrative system entities and service providers for a selected multi-media asset and deliver that asset as desired to the requesting subscriber.

What is claimed:

1. A registration system for assigning unique signature identifications to objects in a multi-media communication network to enable subscribers to access multi-media objects that are stored in storage systems served by said communication network, comprising:
means for receiving data, comprising an object, at said registration system;
means for registering said object by generating a unique signature identification for said received object comprising a digital code of predetermined length, comprising:
means for generating an object payload comprising object-specific information,
means for inserting a digital code that identifies said registration system, and
means for assigning a registrar-specific digital code to uniquely identify said received object.

2. The registration system of claim 1 wherein said means for registering further comprises:
means for combining said object payload, said digital code that identifies said registration system, said registrar-specific digital code, each having a predetermined length, in a predetermined order.

3. The registration system of claim 1, wherein said object comprises one of a media asset and a subscriber application, further comprising:
means for storing said received object in a storage medium for access by subscribers; and
means for indexing and describing said stored received object using said unique signature identification.

4. The registration system of claim 3 wherein said object comprises a media asset, said means for generating an object payload comprises at least one of:
means for generating content expiry data that defines a date when said object is no longer available for access by said subscribers;
means for generating a content rating that defines characteristics of a content of said object;
means for generating quality of service data; and
means for generating version data that identifies a version of said received object.

5. The registration system of claim 3 wherein said object comprises a subscriber application, said means for generating an object payload comprises at least one of:
means for generating subscriber ratings data;
means for generating subscriber permissions data;
means for generating subscriber device data;
means for generating subscriber service provider identification data.

6. The registration system of claim 3 further comprising:
means, responsive to receipt of a query from a subscriber where said query includes a unique signature identification for an object, for identifying an object stored on said storage medium that corresponds to said unique signature identification included in said query;
means, responsive to receipt of a query from a subscriber where said query includes a unique signature identification for said subscriber, for identifying object access permissions for said subscriber that corresponds to said unique signature identification included in said query; and
means for retrieving said stored object from said storage medium where said subscriber's object access permissions authorize access.

7. A method of operating a registration system for assigning unique signature identifications to objects in a multi-media communication network to enable subscribers to access multi-media objects that are stored in storage systems served by said communication network, comprising the steps of:
receiving data, comprising an object, at said registration system;
registering said object by generating a unique signature identification for said received object comprising a digital code of predetermined length, comprising:
generating an object payload comprising object-specific information,
inserting a digital code that identifies said registration system, and
assigning a registrar-specific digital code to uniquely identify said received object.

8. The method of operating a registration system of claim 7 wherein said step of registering further comprises:
combining said object payload, said digital code that identifies said registration system, said registrar-specific digital code, each having a predetermined length, in a predetermined order.

9. The method of operating a registration system of claim 7, wherein said object comprises one of a media asset and a subscriber application, further comprising the steps of:
storing said received object in a storage medium for access by subscribers; and
indexing said stored received object using said unique signature identification.

10. The method of operating a registration system of claim 9 wherein said object comprises a media asset, said step of generating an object payload comprises at least one of:
generating content expiry data that defines a date when said object is no longer available for access by said subscribers;
generating a content rating that defines characteristics of a content of said object;
generating quality of service data; and
generating version data that identifies a version of said received object.

11. The method of operating a registration system of claim 9 wherein said object comprises a subscriber application, said step of generating an object payload comprises at least one of:
generating subscriber ratings data;
generating subscriber permissions data;
generating subscriber device data;
generating subscriber service provider identification data.

12. The method of operating a registration system of claim 9 further comprising the steps of:
identifying, in response to receipt of a query from a subscriber where said query includes a unique signature identification for an object, an object stored on said storage medium that corresponds to said unique signature identification included in said query;
identifying, in response to receipt of a query from a subscriber where said query includes a unique signature identification for said subscriber, object access permissions for said subscriber that corresponds to said unique signature identification included in said query; and
retrieving said stored object from said storage medium where said subscriber's object access permissions authorize access.

13. A registration system for assigning unique signature identifications to objects in a multi-media communication network to enable subscribers to access multi-media objects that are stored in storage systems served by said communication network, comprising:
means for receiving data, comprising an object, at said registration system;
means for registering said object by generating a unique signature identification for said received object comprising a digital code of predetermined length, comprising:
means for generating a segment of said unique signature identification that comprises a set of immutable data, and
means for generating a segment of said unique signature identification that comprises a set of dynamic data comprising object-specific information that can vary during the existence of said object.

14. The registration system of claim 13 wherein said means for registering further comprises:
means for combining said segment of said unique signature identification that comprises a set of immutable data, said segment of said unique signature identification that comprises a set of dynamic data, each having a predetermined length, in a predetermined order.

15. The registration system of claim 13, wherein said object comprises one of a media asset and a subscriber application, further comprising:
means for storing said received object in a storage medium for access by subscribers; and
means for indexing said stored received object using said unique signature identification.

16. The registration system of claim 13 wherein said object comprises a media asset, said means for generating an object payload comprises at least one of:
means for generating content expiry data that defines a date when said object is no longer available for access by said subscribers;
means for generating a content rating that defines characteristics of a content of said object;
means for generating quality of service data; and
means for generating version data that identifies a version of said received object.

17. The registration system of claim 16 wherein said object comprises a subscriber application, said means for generating an object payload comprises at least one of:
means for generating subscriber ratings data;
means for generating subscriber permissions data;
means for generating subscriber device data;
means for generating subscriber service provider identification data.

18. The registration system of claim 16 wherein said means for registering comprises:
means, responsive to receipt of a query from a subscriber where said query includes a unique signature identification for an object, for identifying an object stored on said storage medium that corresponds to said unique signature identification included in said query;
means, responsive to receipt of a query from a subscriber where said query includes a unique signature identification for said subscriber, for identifying object access permissions for said subscriber that corresponds to said unique signature identification included in said query; and
means for retrieving said stored object from said storage medium where said subscriber's object access permissions authorize access.

19. A method of operating a registration system for assigning unique signature identifications to objects in a multi-media communication network to enable subscribers to access multi-media objects that are stored in storage systems served by said communication network, comprising:
receiving data, comprising an object, at said registration system;
registering said object by generating a unique signature identification for said received object comprising a digital code of predetermined length, comprising:
generating a segment of said unique signature identification that comprises a set of immutable data, and
generating a segment of said unique signature identification that comprises a set of dynamic data comprising object-specific information that can vary during the existence of said object.

20. The method of operating a registration system of claim 19 wherein said step of registering further comprises:
combining said segment of said unique signature identification that comprises a set of immutable data, said segment of said unique signature identification that comprises a set of dynamic data, each having a predetermined length, in a predetermined order.

21. The method of operating a registration system of claim 19, wherein said object comprises one of a media asset and a subscriber application, further comprising the steps of:
storing said received object in a storage medium for access by subscribers; and
indexing said stored received object using said unique signature identification.

22. The method of operating a registration system of claim 19 wherein said object comprises a media asset, said step of generating an object payload comprises at least one of:
generating content expiry data that defines a date when said object is no longer available for access by said subscribers;
generating a content rating that defines characteristics of a content of said object;
generating quality of service data; and
generating version data that identifies a version of said received object.

23. The method of operating a registration system of claim 22 wherein said object comprises a subscriber application, said step of generating an object payload comprises at least one of:
generating subscriber ratings data;
generating subscriber permissions data;
generating subscriber device data;
generating subscriber service provider identification data.

24. The method of operating a registration system of claim 19 wherein said step of registering comprises:
identifying, in response to receipt of a query from a subscriber where said query includes a unique signature identification for an object, an object stored on said storage medium that corresponds to said unique signature identification included in said query;
identifying, in response to receipt of a query from a subscriber where said query includes a unique signature identification for said subscriber, object access permissions for said subscriber that corresponds to said unique signature identification included in said query; and
retrieving said stored object from said storage medium where said subscriber's object access permissions authorize access.
